(19) United States
(12) Patent Application Publication
(10) Pub. No.: US 2016/0375796 A1
(43) Pub. Date: Dec. 29, 2016

(54) TRANSPORT SYSTEM

(71) Applicant: SIEMENS AKTIENGESELLSCHAFT, MUENCHEN (DE)

(72) Inventor: HASSO GEORG GRUENJES, ERLANGEN (DE)

(21) Appl. No.: 15/190,411

(22) Filed: Jun. 23, 2016

(30) Foreign Application Priority Data
Jun. 23, 2015 (DE) 102015211554.2

(51) Int. Cl. B60M 1/02; B60M 1/22; B60L 5/24; B60M 1/28

(52) U.S. Cl. CPC B60M 1/02; B60M 1/28; B60M 1/22; B60L 5/24

(57) ABSTRACT

A transport system includes a non-rail-bound, electric or hybrid-electric vehicle, an overhead contact line system along a lane for providing electrical energy, and a pantograph on the vehicle feeding electrical energy through a sliding contactor to line system contact wires. A detection device on the vehicle detects a position-dependent contact wire height and has a position determination system for a current detection position of the vehicle and a sensor system above a wheel level determining a contact wire height above a roadway at the detection position. A monitoring center has a storage device storing position-dependent target ranges for non-critical contact wire heights. A communication device transmits data between the monitoring center and the vehicle and contact wire heights detected on the vehicle with detection positions to the monitoring center. Critical contact wire heights within the line system can thus be quickly and centrally identified.

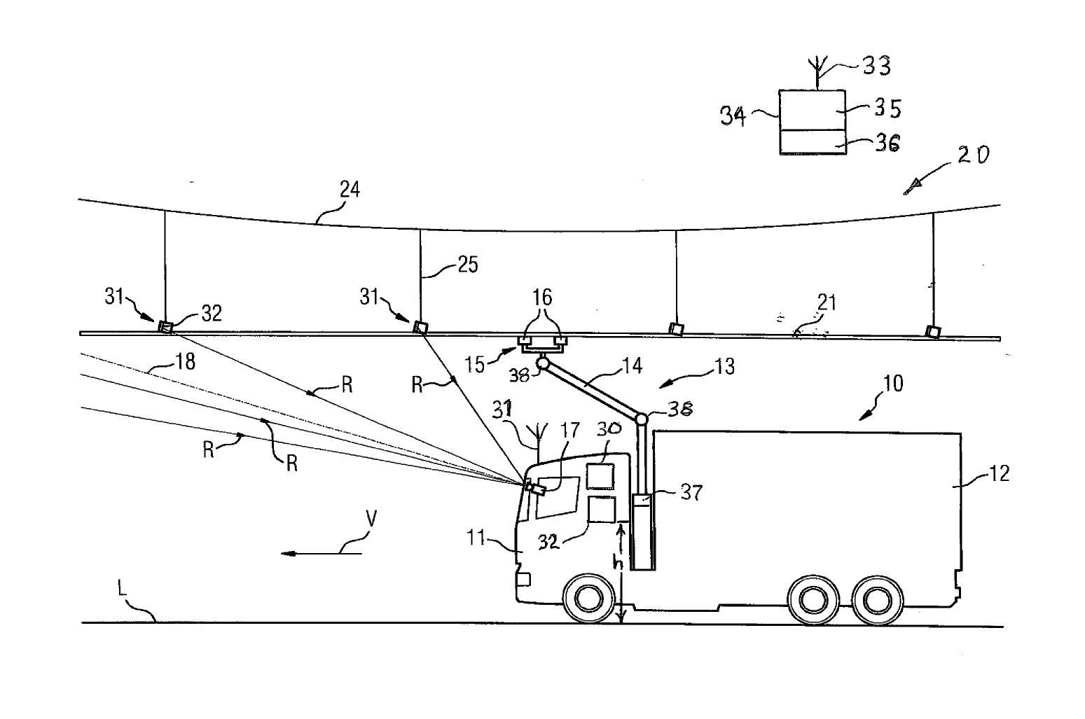

### CROSS-REFERENCE TO RELATED APPLICATION

This application claims the priority, under 35 U.S.C. §119, of German Patent Application DE 10 2015 211 554.2, filed Jun. 23, 2015; the prior application is herewith incorporated by reference in its entirety.

### BACKGROUND OF THE INVENTION

### Field of the Invention

The invention relates to a transport system including a non-rail-bound, electrically or hybrid-electrically driven vehicle, a two-pole overhead contact line system disposed at least in sections along a lane for the vehicle for providing electrical energy, and a pantograph of the vehicle for feeding electrical energy through a sliding contactor to the contact wires of the overhead contact line system which are constructed as conductor pairs.

A transport system of that type is known from German Patent Application DE 10 2012 205 276 A1, for instance. In that transport system, a lateral relative position of the pantograph in relation to the contact wires of the overhead contact line is calculated from a current vehicle position, which is determined by a position determination system, and from contact wire positions along the lane stored in a database. The contact wire positions along the electrified lane are firstly stored in the database in accordance with the configuration of the overhead contact line system. The lateral relative position is detected, however, against the background of activating a laterally adjustable pantograph in such a way that the sliding strips thereof do not lose contact with the contact wires due to driving inaccuracies.

However, in order to maintain a controlled vehicle operation on the overhead contact line system, the height of the contact wires above the roadway level is an important operating variable, which is to be observed by the operator of the overhead contact line system. The contact wire height may change, however, due to contributory factors on the contact wire and/or roadway side. Since the contact wires are part of a catenary system of the overhead contact line system suspended through cantilevers on poles, the sag of the contact wires changes between two support points due to temperature-dependent length changes in the contact wires, cross-wind loads, ice and changes in the tensioning system. Similarly, the roadway level upon which the wheels of the vehicle stand can change significantly as compared with the originally configured roadway level due to maintenance work, road damage, dirt, snow, and objects on the roadway and due to ground frost.

As long as the contact wire height lies within a predeterminable target range, the vehicles attuned to that target range can be operated with their pantographs without any problem, since the lifting devices of the pantographs can push the sliding strips with the required contact force against the contact wires. If the contact wire height is too high however, that may result in contact interruptions between sliding strips and contact wires, as a result of which undesirably arcs may occur and may interrupt the energy supply. If the contact wire height is too low, that results in increased sliding strip wear due to increased contact force. In the extreme case, it may even result in collisions between vehicle parts and the overhead contact line system. It is therefore known to selectively check the contact wire heights of the overhead contact line system by performing occasional maintenance trips.

### SUMMARY OF THE INVENTION

It is accordingly an object of the invention to provide a transport system, which overcomes the hereinafore-mentioned disadvantages of the heretofore-known systems of this general type and in which the contact wire height of the overhead contact line system can be better checked.

With the foregoing and other objects in view there is provided, in accordance with the invention, a transport system including a non-rail-bound, electrically or hybrid-electrically driven vehicle, a two-pole overhead contact line system disposed at least in sections along a lane for the vehicle for providing electrical energy, and a pantograph of the vehicle for feeding electrical energy through a sliding contactor to the contact wires of the overhead contact line system which are constructed as conductor pairs. A detection device is disposed on the vehicle side for detecting a position-dependent contact wire height. The detection device has a position determination system for determining a current detection position of the vehicle and a sensor system disposed at an assembly height above a wheel level of the vehicle for determining the contact wire height of the contact wires above the roadway level at the detection position. The contact wire height determined at a detection position is accordingly composed of the assembly height of the sensor system and the detected vertical distance between the sensor system and the contact wires. The sensor system can be based on an optical measurement by using laser beams for instance. Furthermore, the transport system includes a monitoring center with a storage device, in which position-dependent target ranges for non-critical contact wire heights of the overhead contact line system are stored. Finally, the transport system includes a communication device for transmitting data between the monitoring center and the vehicle, through the use of which contact wire heights with assigned detection positions detected on the vehicle side can be transmitted to the monitoring center. The wireless transmission mode can take place in predeterminable time or distance intervals or at predetermined positions. A current item of information relating to contact wire heights of the overhead contact line system to be monitored is present in this case in the monitoring center and is transmitted by a plurality of vehicles using the electrified lane.

In accordance with another advantageous feature of the transport system of the invention, the monitoring center has an evaluation device, through the use of which it is possible to check whether or not a contact wire height transmitted by a vehicle lies within the target range stored for the assigned detection position. Through the use of this central evaluation of the transmitted contact wire heights, by comparison with the stored target ranges, it is easily possible to ascertain whether or not a critical state of the overhead contact line system or the lane is available at a detection position.

In accordance with a further preferred feature of the transport system of the invention, the monitoring center is configured, by using the communication device, to transmit a warning message to a vehicle, which is approaching a detection position, for which the evaluation device has determined during the last check that the contact wire height lies outside of the target range. The warning message can be indicated, for instance, by way of a display of a driver assistance system and can prepare the driver of the vehicle for possibly bridging the critical position or stretch with an excessively low or high contact wire height with a lowered pantograph.

In accordance with an added advantageous feature of the transport system of the invention, the monitoring center is configured to generate a service order to check the overhead contact line system and/or the roadway at a detection position, for which the evaluation device has established during the last check that the contact wire height lies outside of the target range. The appropriate road maintenance depot which is responsible for the repair of the roadway, but also the operator of the overhead contact lines system, who is responsible for its maintenance, can be informed of the detection position of the critical contact wire height. As a result, the critical situation can be eliminated as quickly as possible.

In accordance with a concomitant preferred feature of the transport system of the invention, a sensor device is disposed on the vehicle side for determining a position-dependent contact force between the pantographs and contact wires and/or for determining a position-dependent attack angle of the pantograph relative to the contact wires, wherein the determined contact forces and/or attack angle can be transmitted by using the communication device to the monitoring center, and on the basis of which the detected contact wire heights are evaluated by using the evaluation device. The contact force between the pantographs and the contact wires and the attack angle, which a mounting rod of the pantograph covers with the contact wires, are vehicle-specific parameters, which may suggest a current contact wire height. In this respect, these parameters can be used to verify and improve the contact wire heights detected by the detection device.

### BRIEF DESCRIPTION OF THE SINGLE VIEW OF THE DRAWING

The FIGURE of the drawing is a diagrammatic, side-elevational view of a vehicle disposed on a roadway below an overhead conductor system.

### DETAILED DESCRIPTION OF THE INVENTION

Referring now in detail to the single FIGURE of the drawing, there is seen a transport system according to the invention which includes a non-rail-bound, electrically-driven or hybrid-electrically driven vehicle 10. The vehicle 10 is constructed as a diesel-electrically driven truck which has a driver's cab 11, a load-carrying structure 12 disposed at the rear and a current collector 13 supported between the cab 11 and the structure 12 for the supply of electrical energy between a two-pole overhead conductor system 20 of the transport system and the vehicle. The current collector 13 has two support arms 14 that carry a pantograph assembly 15 with contact strips 16.

The overhead conductor system 20 has contact wires 21 constructed as supply and return conductors that run parallel to each other above a lane L of a roadway for the vehicle 10 and are contacted by the contact strips 16. Two catenary wires 24 run along the lane L and one contact wire 21 is hung from each of the catenary wires 24 by suspension cable 25.

A detection device 17, such as a video detector, disposed on the vehicle 10 detects a position-dependent height of the contact wires 21. The video detector 17 has an acquisition axis 18 oriented in a direction of travel V of the vehicle for taking video images of marking elements in the form of angle pieces 31 with retro-reflective reflection surfaces 32, in such a way that light R reflected from the reflection surface 32 is received by the video detector 17 and the height of the wires is determined, as described in U.S. application Ser. No. 14/865,218, filed Sep. 25, 2015. The sensor system can also be based on an optical measurement by using laser beams, for instance.

The detection device 17 also has a position determination system 30, such as a GPS, for determining a current detection position of the vehicle 10 along the lane L and a sensor system 32 disposed at an assembly height h above a wheel-to-road level of the vehicle 10 for determining the height of the contact wires 21 above the roadway level at the detection position.

A monitoring center 34 has a storage device or memory 36 in which position-dependent target ranges for non-critical contact wire heights of the overhead line conductor system 20 are stored. Communication devices or antennas 31, 33 respectively disposed on the vehicle 10 and on the monitoring center 34 transmit data between the monitoring center 34 and the vehicle 10, so that the heights of the contact wires 21 detected at the vehicle 10 with detection positions assigned by the position determination system 30 can be transmitted to the monitoring center 34.

The monitoring center 34 has an evaluation device 35 with which it is possible to verify whether or not the height of a contact wire 21 transmitted by a vehicle 10 lies within a target range stored for the assigned detection position.

The monitoring center 34 may use the communication device 31 to transmit a warning message to a vehicle 10 which is approaching a detection position for which the evaluation device 35 has determined during the last check, that the vehicle wire height lies outside of the target range.

The monitoring center 34 may also generate a service order to check the overhead conductor system 20 and/or the roadway at a detection position, for which the evaluation device 35 has established during the last check that the contact wire height lies outside of the target range.

Another sensor device 37 is disposed on the vehicle for determining a position-dependent contact force between the pantograph assembly 15 and the contact wires 21 and/or for determining a position-dependent attack angle of the pantograph assembly 15 relative to the contact wires 21 by using the angle and force exerted at joints 38 of the support arms 14 and a mounting rod of the pantograph. The detection device 17 may also determine the attack angle of the pantograph assembly 15 by evaluating the reflection from the surfaces 32. The determined contact forces and/or attack angle can be transmitted to the monitoring center 34 by the communication device 31, 33 and the detected contact wire heights are evaluated by the evaluation device 35 on the basis thereof.

1. A transport system, comprising:
a non-rail-bound, electrically or hybrid-electrically driven vehicle;
a two-pole overhead contact line system disposed at least in sections along a lane at a level of a roadway for accommodating said vehicle, said contact line system having contact wires constructed as conductor pairs for providing electrical energy;
a pantograph disposed on said vehicle and having a sliding contactor for feeding electrical energy to said contact wires;
a detection device disposed on said vehicle for detecting a position-dependent height of said contact wires, said detection device having a position determination system for determining a current detection position of said vehicle and a sensor system disposed at an assembly height above a wheel level of said vehicle for determining said contact wire height of said contact wires above the roadway level at said detection position;
a monitoring center having a storage device for storing position-dependent target ranges for non-critical contact wire heights of said overhead contact line system; and
a communication device for transmitting data between said monitoring center and said vehicle and for transmitting said contact wire heights detected at said vehicle with assigned detection positions to said monitoring center.

2. The transport system according to claim 1, wherein said monitoring center has an evaluation device for verifying if a contact wire height transmitted by a vehicle lies within said target range stored for said assigned detection position.

3. The transport system according to claim 2, wherein said monitoring center uses said communication device to transmit a warning message to a vehicle approaching a detection position for which said evaluation device has determined during a previous check that the vehicle wire height lies outside of said target range.

4. The transport system according to claim 2, wherein said monitoring center generates a service order to check at least one of said overhead contact line system or the roadway at a detection position for which said evaluation device has established during a previous check that the contact wire height lies outside of said target range.

5. The transport system according to claim 1, which further comprises:
another sensor device disposed on said vehicle for determining at least one of a position-dependent contact force between said pantograph and said contact wires or a position-dependent attack angle of said pantograph relative to said contact wires;
said communication device transmitting at least one of said determined contact force or said attack angle to said monitoring center; and
said evaluation device evaluating said detected contact wire heights based on at least one said determined contact forces or said attack angle.
